(19) United States
(12) Patent Application Publication
(10) Pub. No.: US 2010/0319303 A1
(43) Pub. Date: Dec. 23, 2010

(54) CONTAINER WITH MOISTURE CONTROL CAPACITY

(75) Inventors: Benoit Portier, Mehun sur Yevre (FR); Florence Benois, Saint-Maur-des-Fosses (FR)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: AIRSEC, Choisy Le Roi (FR)

(21) Appl. No.: 12/599,358

(22) PCT Filed: May 6, 2008
(86) PCT No.: PCT/EP2008/055532

§ 371 Date: Sep. 7, 2010

Related U.S. Application Data
(60) Provisional application No. 60/916,374, filed on May 7, 2007.

(51) Int. Cl. B65B 31/04; C09K 3/00; B65D 81/26

(52) U.S. Cl. 53/432; 252/194; 206/204

(57) ABSTRACT

A multifunctional vessel which for holding products, including pharmaceutical products, such as DPI or soft gel tablets, which vessel includes an outer vessel, and a moisture control material, comprising a moisture control substance, such as silica gel or clay, blended with a plastic material placed within or formed as part of the outer vessel, wherein the moisture control substance is partially or fully hydrated after formation of the final product. The moisture control material can be formed in any shape for placement within the vessel or it can be layered with the vessel to form an inner layer thereof.

### BACKGROUND OF INVENTION

One preferred embodiment of the invention relates to multifunctional vessels, such as pharmaceutical or neutraceutical vessels, containing a moisture control material which may be placed within, secured within or form a portion of the multifunctional vessel. Another preferred embodiment of the invention relates to vessels for holding commercial products wherein the relative humidity level within the vessel can be regulated. Another preferred embodiment relates to a moisture control material that can be placed within a vessel, wherein the moisture control material comprises a blend of a moisture control substance and a plastic material, wherein the moisture control substance is hydrated before or preferably after formation of the moisture control material.

There are many products which are enhanced by the maintenance of predetermined levels of relative humidity within containers for those products. These products may include pharmaceutical products, such as dry powder inhalers (DPI) and soft gel tablets and various other consumer products.

Accordingly, it is one object of an embodiment of the invention to prepare a vessel for holding products which contains a moisture control material comprising a blend of a moisture control substance and a plastic material, wherein the moisture control substance is hydrated before or preferably after formation of the moisture control material.

These and other objects are obtained by the composition, process for the preparation of the composition and process of use of the composition disclosed herein.

### SUMMARY OF THE INVENTION

One embodiment includes a multifunctional vessel containing a moisture control material, comprising a plastic composition blended with at least one moisture control substance, preferably a silica gel or clay, and optionally also including a color pigment, scent agent and/or other additives, such as an oxygen absorber, placed within the multifunctional vessel, such as a vessel to hold pharmaceuticals, such as DPI or soft gel tablets, wherein before or preferably after formation of the vessel, the moisture control substance is partially or fully hydrated.

Another embodiment includes a multifunctional vessel containing a moisture control material comprising at least one moisture control substance, preferably silica gel and/or clay, blended into a plastic composition utilized with a gas adsorbing product, particularly an oxygen absorbing container, which is placed within the multifunctional vessel, wherein before or preferably after formation of the vessel, the moisture control substance is partially or fully hydrated.

A further embodiment includes a multifunctional vessel containing a moisture control material containing a partially or fully hydrated moisture control substance, whose moisture level is predetermined and a second moisture control material containing a moisture control substance that is not hydrated, wherein the combination of these materials results in a predetermined relative humidity within the vessel. Alternatively, the hydration level of each of the moisture control substances can be established at any level that is useful for the production of the end product.

A further embodiment includes a moisture control material useful for inclusion in a multifunctional vessel, wherein the moisture control material comprises a moisture control substance blended with a plastic material, wherein the moisture control substance is hydrated prior to or preferably after formation of the moisture control material.

### DETAILED DESCRIPTION OF THE INVENTION

One embodiment of the invention comprises a multifunctional vessel useful for holding a variety of commercial products, such as pharmaceuticals, such as DPI and soft gel tablets, neutraceuticals, food and other commercial products, which vessel contains at least a moisture control material, which is at least partially produced from a blend of a plastic material and at least one moisture control substance, which is secured within or forms a portion of the multifunctional vessel, wherein the moisture control substance is partially or fully hydrated before or preferably after formation of the moisture control material.

In another embodiment the multifunctional vessel comprises a conventional container manufactured from conventional materials, such as plastic or glass. Placed within this container is the moisture control material. The moisture control material is formed from a plastic material blended with a moisture control substance, preferably silica gel and/or clay, wherein the moisture control substance is partially or fully hydrated before or preferably after formation of the moisture control material.

Among the plastic materials that can be utilized is a single thermoplastic material that is compatible with the products which are placed within the vessel and which can be easily blended with the moisture control substance. The plastic materials may be selected from a thermoplastic material, such as, but not limited to, polystyrenes, polyolefins, polyethylene, polypropylene, polyacrylates, polymethacrylates, polyamides, polyesters, and polyvinyl chloride. Non-limiting examples of copolymers include: styrene-butadiene rubbers (SBR), styrene-ethylene-butadiene-styrene copolymers (SEBS), butyl rubbers, ethylene-propylene rubbers (EPR), ethylene-propylene-diene monomer rubbers (EPDM), ethylene-vinyl acetate copolymers (EVA), ethylene-acrylate or butadiene-acrylonitrile, maleic anhydride modified polymers and copolymer, and grafted copolymers. In one preferred embodiment, the plastic material is polypropylene, polyethylene or polystyrene, preferably a high density polyethylene.

In another preferred embodiment, an inner layer of the multifunctional vessel or a separate insert for placement within a vessel can be produced solely or partially from a moisture control material, which comprises more than one thermoplastic material and at least one moisture control substance, preferably silica gel and/or clay, wherein the moisture control substance is partially or fully hydrated before or preferably following formation of the inner layer or separate insert, and wherein the moisture control material controls the level of relative humidity within the vessel. The thermoplastic materials can be any materials that exhibit thermoplastic properties, including but not limited to, a copolymer of two or more monomers, a mixture of two or more polymers from single monomers, a mixture of two or more copolymers and a mixture of at least one polymer from a single monomer and at least one copolymer. Non-limiting examples of polymers from single monomers include: polystyrenes, polyolefins, polyethylene, polypropylene, polyacrylates, polymethacrylates, polyamides, polyesters, and polyvinyl chloride. Non-limiting examples of copolymers include: styrene-butadiene rubbers (SBR), styrene-ethylene-butadiene-styrene copolymers (SEBS), butyl rubbers, ethylene-propylene rubbers (EPR), ethylene-propylene-diene monomer rubbers (EPDM), ethylene-vinyl acetate copolymers (EVA), ethylene-acrylate or butadiene-acrylonitrile, maleic anhydride modified polymers and copolymers, and grafted copolymers.

When blends of thermoplastic materials are combined with the moisture control substance to form the moisture control material, it has been observed that one of the components of the thermoplastic blends tends to enrich at the surface together with the moisture control substance while the other component tends to enrich towards the center of the composition. However, it has been discovered that only in the melted state does the moisture control substance tend to migrate towards the surface of the composition. Care must be taken to prepare such articles so that the moisture control substance and the thermoplastic material exhibit the separation described hereinafter while in the molten or flowable state. For example, the thermoplastic material may be prepared from a blend of linear low density polyethylene (LLDPE), low density polyethylene (LDPE) and ethylene vinyl acetate (EVA) copolymer, wherein each of the components include an ethylene monomeric unit. “Separation” as used herein defines a concentration gradient difference and does not necessarily mean 100% separation of the components into distinct phases. Similarly, “layered” as used herein means a significant change in concentration gradient such that the product appears to be layered, and does not necessarily mean a layer of one component and a second layer of a different component. “Gradient” means that the concentration of the moisture control substance varies with distance from the surface of a product manufactured from the moisture control material.

In order to achieve this phase separation, it has been found preferable to use as a thermoplastic component a blend of at least one polymer derived from a single monomer with at least one copolymer. Preferably the copolymer contains the monomer of the single monomer component so that the two polymers are compatible. If two or more copolymers are mixed to form the thermoplastic material, they should preferably contain at least one common monomer.

The moisture control substance can be any substance capable of regulating the relative humidity within the vessel. The moisture control substance can include known materials which can be partially or fully hydrated, including but not limited to silica gel, bentonite clay, montmorillonite clay, and mixtures thereof. In a preferred embodiment the moisture control substance comprises silica gel and/or clay. The purpose of the moisture control substance is to control the relative humidity within the vessel in which the moisture control material is placed. After hydration of the moisture control substance, the relative humidity is controlled by the moisture control substance absorbing excess moisture from the vessel when the moisture level within the vessel exceeds the desired level and/or promoting the retention of moisture inside the vessel by adding moisture to the vessel if the moisture level inside the vessel falls below the desired level.

Preferably, the air inside the multifunctional vessel is set at a desired relative humidity level at the time the moisture control material is placed within the vessel and the vessel is sealed. AS the contents within the vessel are used, the relative humidity level may change depending on many factors, including how many times the vessel is opened and closed, the amount of moisture that leaks through the lid of the vessel, the permeability of the material of the vessel and the relative humidity level outside of the vessel.

The manufacturer of the vessel can control the level of the relative humidity within the vessel by the choice and quantity of the moisture control substance, choice of the plastic material and by the level of hydration of the moisture control substance after formation of the final product. Another method of controlling the level of the relative humidity is to include within the vessel as a separate component, or as a component of the vessel itself, a plastic material that contains a moisture control substance that has not been hydrated or has only been minimally hydrated.

A preferred range of relative humidity for the moisture control material is between 5% relative humidity and 40% relative humidity. When the products placed within the vessel are pharmaceutical products, the relative humidity may be as low as 5%. However, when certain commercial products are present within the vessel, the relative humidity may need to be as high as 40%. However, in a preferred range the relative humidity is between 5% relative humidity and 25% relative humidity.

In order for the moisture control material to maintain the relative humidity at the desired level within the vessel, it is necessary that the moisture control substance that is introduced into the plastic material be sufficiently hydrated before or preferably after formation of the moisture control material so that it maintains the predetermined level of relative humidity of the atmosphere within the vessel that is desired. In addition, it is necessary that there be a sufficient quantity of the moisture control substance with the appropriate hydration present within the moisture control material to maintain the desired relative humidity within the vessel.

In a preferred embodiment the moisture control substance comprises silica gel and/or clay, which is hydrated to the desired level before, or preferably after formation of the product that contains both the moisture control substance and the plastic composition. One method of hydrating the moisture control material containing the plastic composition and the moisture control substance after its formation is by placing the final product made from the blended material in a controlled or regulated humidity environment, such as a sealed room or oven, where the humidity of the environment is regulated within a desired relative humidity range or ranges. The moisture control material should be left in the controlled or regulated humidity environment long enough for the moisture control substance to become sufficiently hydrated. After the moisture control material is removed from the controlled or regulated humidity environment, the moisture content of the moisture control substance can be measured or tested by well known mechanisms and instruments, such as a hygrometer, balance, desiccant balance or moisture analyzer to ensure that it has been sufficiently hydrated.

Other methods can also be used to hydrate the moisture control substance before or preferably after it has been blended with the plastic composition to form the final product, which methods are known in the industry.

Once the humidity level of the moisture control substance has been determined, that humidity level may be decreased by drying the moisture control substance or increased by placing it for an additional period of time within the controlled or regulated humidity environment.

In one preferred embodiment, the moisture control substance comprises silica gel and/or clay. Silica gel is a porous, granular, chemically inert, amorphous form of silicon dioxide which is capable of absorbing and desorbing water vapor in order to reach equilibrium with the surrounding environment. Silica gel has a long life span and continues to absorb or desorb moisture for an extended period of time. The particular type of silica gel that is selected can be determined by the person skilled in the art reviewing the particular desired environment of the vessel.

If desired, other functionalities can be provided for the vessel, such as by adding a material for absorbing various gases, such as oxygen.

A scent may also be incorporated into the plastic material of the moisture control material, if desired, or a scent can be incorporated into the composition of a separate insert placed within the vessel. All of these improvements to the multifunctional vessel assist in the preservation and maintenance of the materials present in the vessel.

The relative concentration of thermoplastic material to the moisture control substance may vary depending on the thermoplastic material and the moisture control substance used. In a preferred embodiment, the polymeric structure comprises from 20 wt % to 85 wt % thermoplastic material and from 15 wt % to 80 wt % moisture control substance.

Where applicable, compositions of the moisture control material further include appropriate quantities, up to 10 percent, of organic or inorganic additives that are useful in the field of plastic such as plasticizers, stabilizers, elastomers, dyes and pigments. The composition may be customized to include certain pigments and/or colorants. It is often desirable that the manufactured article have a particular color. A particular color may, for example, enhance aesthetic appeal of the article and may serve to identify the particular brand or manufacturer. Suitable pigments of black, white or colored pigments, as well as extenders may be used. Examples of useful pigments include, without limitation, titanium oxide, zinc oxide, zinc sulfide, barium sulfate, aluminum silicate, calcium silicate, carbon black, black iron oxide, copper chromite black, yellow iron oxides, red iron oxides, brown iron oxides, ocher, sienna, umber, hematite, limonite, mixed iron oxide, chromium oxide, Prussian blue, chrome green, chrome yellow, manganese violet and other well known pigments. Dyes may be employed instead of pigments or in addition to the pigments.

Surprisingly, it has been found that products formed from the moisture control material exhibiting an accumulation of partially or fully hydrated moisture control substance in a “migration zone” in a gradient towards the surface show distinct advantages in preserving a predetermined humidity level compared to structures that contain the same concentration of moisture control substance throughout the product (monolithic structures) and structures that contain the moisture control substance only at the surface.

The polymeric structure of the moisture control material is produced by forming and setting the thermoplastic material after it has been dosed with the moisture control substance. The polymeric structure may be produced by common plastic manufacturing processes, such as extrusion, co-extrusion, injection molding, bi-injection molding, blow molding, and any other methods that involve melting the thermoplastic material to an essentially viscous state. For example, the polymeric structure may be produced by the steps of heating the selected thermoplastic material (or combination of materials) until the thermoplastic material is viscous, adding the selected moisture control substance, blending the moisture control substance into the melted thermoplastic, extruding the thermoplastic—moisture control substance blend, and cooling the thermoplastic—moisture control substance blend. The polymeric structure can then be cut or ground or processed by other means known in the art.

The composition of this embodiment is prepared such that the moisture control substance tends to concentrate in a gradient within the migration zone near the surface of the polymeric composition. In a preferred embodiment, the concentration of the moisture control substance at the surface creates distinct layers of the composition, which are identifiable, i.e., a surface layer that is enriched in the moisture control substance and an interior layer that is depleted of that same moisture control substance. After formation of this embodiment, the moisture control substance, concentrated within the gradient within the migration zone near the surface of the polymeric composition, is hydrated as previously discussed.

A further preferred embodiment is a multifunctional vessel containing not only a moisture control material with a moisture control substance which has been hydrated to a predetermined moisture level, but, a plastic material that contains a moisture control substance that is not hydrated, wherein the combination of these materials results in a predetermined relative humidity level within the vessel. For example, in one particularly preferred embodiment, the composition of the container itself may be partially comprised of a plastic material that contains a moisture control material which may not have been hydrated, preferably an inner layer formed by injection molding. A moisture control material in the form of an insert comprised of a moisture control substance and a plastic material blended together, wherein the moisture control substance is hydrated after formation of the insert, is placed within the vessel. The combination of the plastic material that contains a nonhydrated moisture control substance and a moisture control material comprising a moisture control substance and a plastic material that is hydrated after formation when used in combination results in the formation of an environment with a relative humidity level between zero percent and the level of relative humidity that would be created by the moisture control substance, if fully hydrated. Alternatively, the level of hydration of the two products can be modified to achieve a wide range of relative humidity levels within the vessel. By use of this combination of materials and by modifying the level of hydration of the moisture control substance within the moisture control material, precise levels of relative humidity can be maintained within the multifunctional vessel.

Other modifications to the composition and hydration of the materials that are placed within the vessel are within the scope of preferred embodiment of the invention. In addition, materials with other functionalities, such as materials for absorbing various gases, such as oxygen, or materials that provide a scent within the vessel may be incorporated into the vessel and are also within the scope of the preferred embodiments of the invention. In one preferred embodiment an oxygen absorbing canister or sachet is also placed within the multifunctional vessel.

It will be apparent from the forgoing that while particular forms of the invention have been illustrated various modifications can be made without departing from the scope of the invention. Accordingly, the invention is not intended to be limited by the specification of the application.

1. A multifunctional vessel for holding commercial products, including pharmaceuticals, such as DPI and soft gel tablets, neutraceuticals, and food, comprising
a vessel, and
a moisture control material placed or secured within the vessel, which moisture control material comprising a blend of a plastic material and at least one moisture control substance, wherein the moisture control substance is at least partially hydrated after formation of the moisture control material.

2. The multifunctional vessel of claim 1 wherein the moisture control substance is selected from the group consisting of silica gel, bentonite clay, montmorillonite clay, and mixtures thereof, preferably silica gel or bentonite clay.

3. The multifunctional vessel of claim 1 wherein the moisture control material comprises an inner layer of the multifunctional vessel or a separate insert placed within the vessel.

4. The multifunctional vessel of claim 1 wherein the moisture control material comprises a blend of from 20 to 85% of the plastic material and 15 to 80% of the moisture

5. The multifunctional vessel of claim 1 wherein the moisture control substance is layered within a gradient within the blend of the plastic material and the moisture control substance is located near a surface thereof.

6. The multifunctional vessel of claim 1 wherein the moisture control material further comprises a scent material and/or a color additive added to the plastic material.

7. The multifunctional vessel of claim 1 further comprising an oxygen absorber.

8. The multifunctional vessel of claim 1 further comprising a second moisture control substance comprising a blend of a plastic material and at least one moisture control substance wherein the moisture control substance is not hydrated prior to introduction into the multifunctional vessel.

9. The multifunctional vessel of claim 1 wherein the moisture control substance is partially hydrated before formation of the moisture control material.

10. A method for controlling the humidity level within a multifunctional vessel for holding commercial products including neutraceuticals, pharmaceuticals, such as DPI and soft gel tablets, and food comprising
blending a plastic material with a moisture control substance to form a moisture control material,
hydrating the moisture control substance within the moisture control material to a preselected hydration level,
placing the hydrated moisture control material within the multifunctional vessel, and
sealing the multifunctional vessel.

11. The method of claim 10 wherein the moisture control substance within the moisture control material is hydrated to a desired level by placing the blend of the plastic material and the moisture control substance within a controlled or regulated humidity environment until the humidity level within the moisture control material is at the predetermined level.

12. The method of claim 10 further comprising adding a color pigment and/or a scent agent to the hydrated moisture control material.

13. The method of claim 10 wherein the plastic material and the moisture control substance are blended such that a substantial percentage of the moisture control substance tends to concentrate in a gradient within a migration zone near the surface of the moisture control material.

14. The method of claim 10 wherein the multifunctional vessel further comprises adding a second moisture control material to the vessel comprising a blend of a plastic material and a moisture control substance wherein the moisture control substance is not hydrated prior to placement within the multifunctional vessel.

15. A moisture control material for placement within a multifunctional vessel comprising a blend of a plastic material and at least one moisture control substance, wherein the moisture control substance is at least partially hydrated after formation of the moisture control material.

16. The moisture control material of claim 15 wherein the moisture control substance is selected from the group consisting of silica gel, bentonite clay, montmorillonite clay, and mixtures thereof, preferably silica gel or bentonite.

17. The moisture control material of claim 15 wherein the moisture control substance is partially hydrated before formation of the moisture control material.
